(19) United States
(12) Patent Application Publication
(10) Pub. No.: US 2024/0087797 A1
(43) Pub. Date: Mar. 14, 2024

(54) INDUCTIVE DEVICE

(71) Applicant: DANFOSS EDITRON OY, LAPPEENRANTA (FI)

(72) Inventors: Mikko PIISPANEN, Lappeenranta (FI); Matti ISKANIUS, Lappeenranta (FI); Tero JARVELAINEN, Lappeenranta (FI); Anssi SUURONEN, Lappeenranta (FI)

(21) Appl. No.: 18/519,149

(22) Filed: Nov. 27, 2023

Related U.S. Application Data
(62) Division of application No. 15/816,114, filed on Nov. 17, 2017.

(30) Foreign Application Priority Data
Nov. 30, 2016 (EP) 16201298.3

(51) Int. Cl. H01F 27/28; H01F 27/02; H01F 27/16; H01F 27/22; H01F 27/245; H01F 27/32; H01F 37/00

(52) U.S. Cl. CPC H01F 27/2895; H01F 27/025; H01F 27/16; H01F 27/22; H01F 27/245; H01F 27/324; H01F 37/00

(57) ABSTRACT

An inductive device comprises a toroidal core and at least one electric conductor wound around the toroidal core and constituting at least one winding. The inductive device comprises a cooling element constituting a cylindrical cavity that contains the toroidal core and the electric conductor so that the axial direction of the toroidal core is parallel with the axial direction of the cylindrical cavity. The shape of the cylindrical cavity and the cross-section of the electric conductor are adapted to match each other to improve heat transfer from the electric conductor to the wall of the cylindrical cavity so that a wall of the cylindrical cavity is provided with axially directed grooves occupied by portions of the electric conductor on an outer perimeter of the winding.

### CROSS REFERENCE TO RELATED APPLICATIONS

This application is a Divisional of application Ser. No. 15/816,114, filed on Nov. 17, 2017, which claims priority under 35 U.S.C. § 119(a) to application Ser. No. 16/201,298.3, filed in Europe on Nov. 30, 2016, all of which are hereby expressly incorporated by reference into the present application.

### FIELD OF THE DISCLOSURE

The disclosure relates to an inductive device comprising a toroidal core, at least one winding wound around the toroidal core, and a cooling element for cooling the inductive device.

### BACKGROUND

Toroidal inductive devices are passive electric components which comprise a toroidal core and one or more windings wound around the toroidal core. The toroidal core is advantageously a magnetically amplifying core which comprises ferromagnetic material. A toroidal inductive device can be for example a part of a filter circuit or an energy storage component of a power electronic converter such as e.g. a direct voltage-to-direct voltage converter. An inherent advantage of a toroidal inductive device is that, due to its symmetry, the amount of magnetic flux that escapes outside the toroidal core, i.e. leakage flux, is low. Therefore, a toroidal inductive device radiates less electromagnetic interference “EMI” than many other inductive devices comprising different core structures such as for example E-I core structures and U-I core structures.

A toroidal inductive device of the kind described above is, however, not free from challenges. One of the challenges is related to cooling of a toroidal inductive device. For example, it is challenging to attach a cooling element on a surface of a toroidal inductive element. One approach is to place a toroidal inductive device into a container which is filled with cooling liquid. Immersing a toroidal inductive element in cooling liquid has however its own challenges. In cases where the cooling liquid is water or other liquid which can be electrically conductive especially when the cooling liquid contains impurities, the insulators of the toroidal inductive element are under a strong stress and even a small leak in the insulations would lead to damages. On the other hand, in cases where the cooling liquid is transformer oil or some other suitable liquid that is electrically non-conductive, there is a need to arrange appropriate measures against unintentional leakages and/or evaporation.

### SUMMARY

The following presents a simplified summary to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

In this document, the word “geometric” when used as a prefix means a geometric concept that is not necessarily a part of any physical object. The geometric concept can be for example a geometric point, a geometric line, a non-linear geometric curve, a geometric plane, a non-planar geometric surface, a geometric spatial room, or any other geometric entity that is zero, one, two, or three dimensional.

In accordance with the invention, there is provided a new inductive device that comprises:
a toroidal core,
at least one electric conductor wound around the toroidal core and constituting at least one winding, where portions of the electric conductor on an outer perimeter of the winding are substantially straight and parallel with the axial direction of the toroidal core, and
a cooling element constituting a cylindrical cavity containing the toroidal core and the electric conductor so that the axial direction of the toroidal core is parallel with an axial direction of the cylindrical cavity and distances from the wall of the cylindrical cavity to different ones of the above-mentioned portions of the electric conductor are substantially equal.

In an inductive device according to the invention, the shape of the wall of the cylindrical cavity and a cross-sectional shape of the electric conductor are adapted to match each other so that the cross-sectional shape of the cylindrical cavity in a geometric plane perpendicular to the axial direction of the cylindrical cavity deviates from a circular shape so as to improve heat transfer from the portions of the electric conductor on the outer perimeter of the winding to the wall of the cylindrical cavity. The wall of the cylindrical cavity is provided with axially directed grooves occupied by the portions of the electric conductor on the outer perimeter of the winding, the portions of the electric conductor occupying the grooves are a distance apart from each other, and a distance from the wall of the cylindrical cavity of the cooling element to the toroidal core in a radial direction of the toroidal core is less than a thickness of the portions of the electric conductor in the radial direction.

It is worth noting that in this document the word “cylindrical” is not limited to cylindrical geometric rooms and/or objects having a circular base but the base of a cylindrical geometric room and/or object can be non-circular as well.

Exemplifying and non-limiting embodiments of the invention are described in accompanied dependent claims.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of un-recited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF THE FIGURES

Exemplifying and non-limiting embodiments of the invention and their advantages are explained in greater detail below in the sense of examples and with reference to the accompanying drawings, in which:

FIGS. 1a, 1b, and 1c illustrate an inductive device according to an exemplifying and non-limiting embodiment of the invention, and

FIG. 2 illustrates a detail of an inductive device according to another exemplifying and non-limiting embodiment of the invention.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

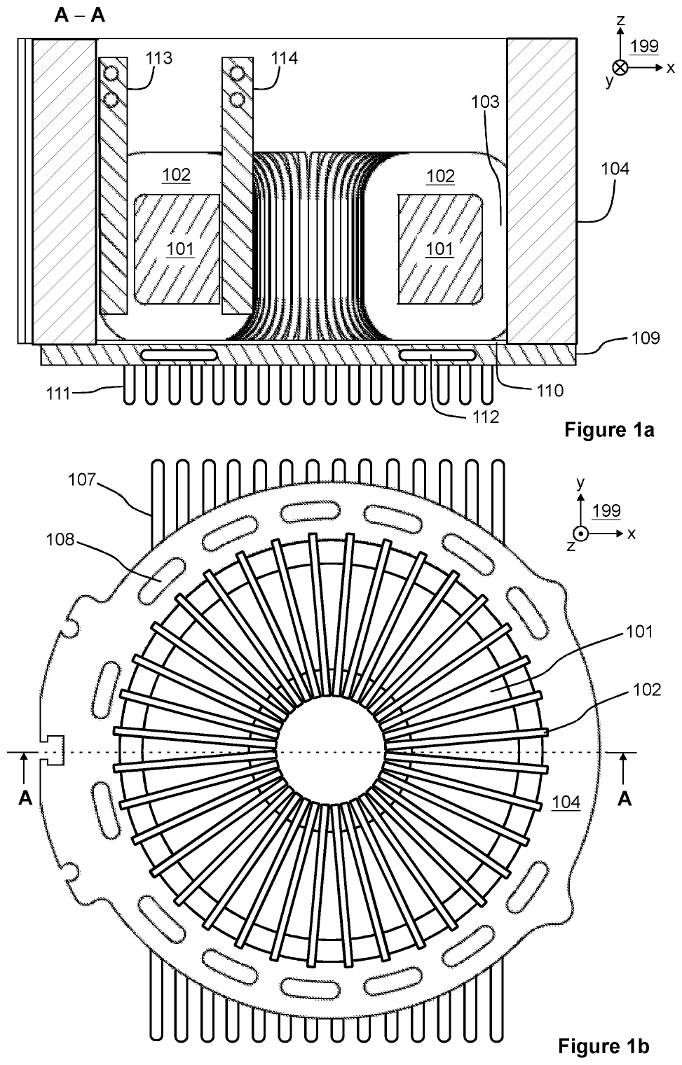

FIGS. 1a and 1 b illustrate an inductive device according to an exemplifying and non-limiting embodiment of the invention. FIG. 1a shows a view of a section taken along a line A-A shown in FIG. 1b. The section plane is parallel with the xz-plane of a coordinate system 199. The inductive device comprises a toroidal core 101. The toroidal core 101 is advantageously a magnetically amplifying core which comprises ferromagnetic material. For example, the toroidal core 101 may comprise an elongated band of steel which is coated with electrically insulating material, and which has been reeled to constitute the toroidal core. For another example, the toroidal core 101 may comprise ring-shaped and planar sheets of steel which are coated with electrically insulating material, and which have been stacked in the axial direction of the toroidal core 101. In the exemplifying situation illustrated in FIGS. 1a and 1 b, the axial direction of the toroidal core 101 is parallel with the z-axis of the coordinate system 199. It is also possible that the toroidal core 101 is made of or comprises ferrite or iron powder composites such as e.g. SOMALOY®-Soft Magnetic Composite.

The inductive device comprises an electric conductor 102 which is wound around the toroidal core 101 and which constitute a winding. The winding is illustrated in FIG. 1c, too. As shown in FIGS. 1a and 1 c, portions of the electric conductor 102 on the outer perimeter of the winding are substantially straight and parallel with the axial direction of the toroidal core 101, i.e. with the z-direction of the coordinate system 199. In FIGS. 1a and 1 c, one of the above-mentioned portions of the electric conductor 102 is denoted with a figure reference 103. The inductive device comprises a cooling element 104 that constitutes a cylindrical cavity whose axial direction is parallel with the z-axis of the coordinate system 199. The cylindrical cavity contains the toroidal core 101 and the electric conductor 102 so that the axial direction of the toroidal core 101 is parallel with the axial direction of the cylindrical cavity. As shown in FIG. 1b, the shape of the cylindrical cavity matches the shape of the outer perimeter of the winding so that distances from the wall of the cylindrical cavity to different ones of the portions of the electric conductor 102 on the outer perimeter of the winding are substantially equal.

To improve heat transfer from the electric conductor 102 to the wall of the cylindrical cavity of the cooling element 104, the cross-section of the electric conductor 102 and the shape of the cylindrical cavity are arranged to match each other so that the cross-section of the electric conductor 102 and the cross-section of the cylindrical cavity differ from a circular shape. The cross-section of the cylindrical cavity is taken along a geometric plane perpendicular to the axial direction of the cylindrical cavity, i.e. the cross-section of the cylindrical cavity is taken along a geometric plane parallel with the xy-plane of the coordinate system 199. In the exemplifying inductive device illustrated in FIGS. 1a-1c, the cross-section of the electric conductor 102 is substantially rectangular and the wall of the cylindrical cavity is provided with axially directed grooves occupied by the above-mentioned portions of the electric conductor 102, e.g. the portion 103. The portions of the electric conductor occupying the grooves are a distance apart from each other, and a distance from the wall of the cylindrical cavity of the cooling element 104 to the toroidal core 101 in a radial direction of the toroidal core 101 is less than a thickness of the portions of the electric conductor in the radial direction.

In the exemplifying inductive device illustrated in FIGS. 1a-1c, the gaps between the wall of the cylindrical cavity and the above-mentioned portions of the electric conductors are filled with electrically insulating solid material. An electrically insulating outer lining of the electric conductor 102 may constitute the electrically insulating solid material filling the above-mentioned gaps.

In an inductive device according to an exemplifying and non-limiting embodiment of the invention, the cooling element 104 comprises cooling fins. In FIG. 1b, one of the cooling fins is denoted with a figure reference 107.

In an inductive device according to an exemplifying and non-limiting embodiment of the invention, the cooling element 104 comprises one or more cooling ducts for conducting cooling fluid. In FIG. 1b, one of the cooling ducts is denoted with a figure reference 108. The cooling fluid can be for example water.

In an inductive device according to an exemplifying and non-limiting embodiment of the invention, the cooling element 104 comprises a bottom section 109 which constitutes a bottom of the cylindrical cavity, and which is in a heat conductive relation with the electric conductor 102. In the exemplifying inductive device illustrated in FIGS. 1a-1c, gaps between the bottom section 109 and the electric conductor 102 are filled with electrically insulating solid material. In the exemplifying case illustrated in FIGS. 1a and 1 b, the electrically insulating outer lining of the electric conductor 102 constitutes a part of the electrically insulating solid material filling the above-mentioned gaps and a sheet 110 of electrically insulating solid material constitutes another part of the electrically insulating solid material filling the above-mentioned gaps. Depending on mechanical and electrical properties of the electrically insulating outer lining of the electric conductor 102, the sheet 110 of electrically insulating solid material may in some cases be needless.

In an inductive device according to an exemplifying and non-limiting embodiment of the invention, the bottom section 109 comprises cooling fins. In FIG. 1a, one of the cooling fins of the bottom section 109 is denoted with a figure reference 111.

In an inductive device according to an exemplifying and non-limiting embodiment of the invention, the bottom section 109 comprises one or more cooling ducts for conducting cooling fluid. In FIG. 1a, one of the cooling ducts of the bottom section 109 is denoted with a figure reference 112.

The exemplifying inductive device illustrated in FIGS. 1a-1c is a choke coil that comprises one winding that comprises connection terminals 113 and 114. It is also possible that an inductive device according to an exemplifying and non-limiting embodiment of the invention comprises two or more windings which cover different sectors of the toroidal core.

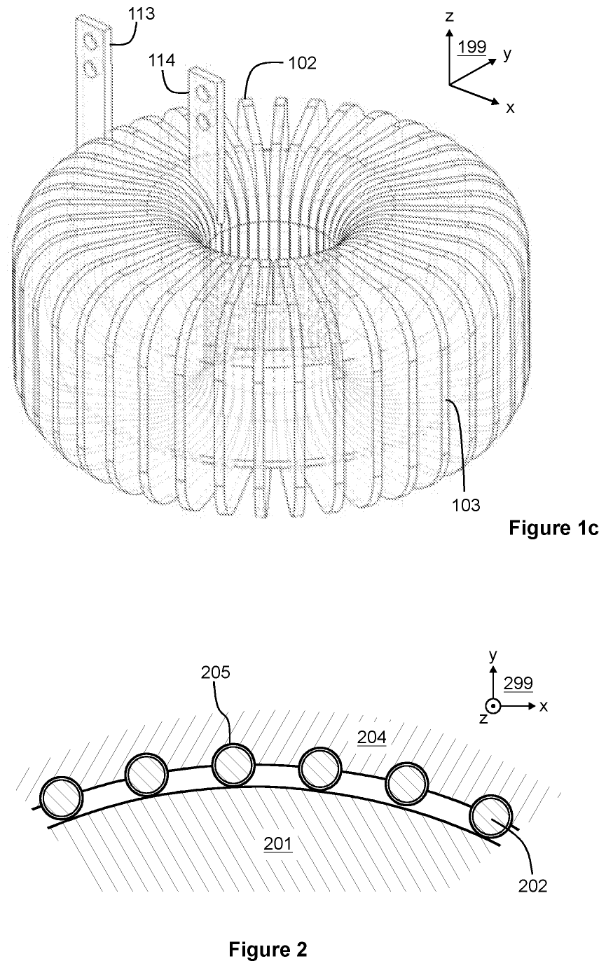

FIG. 2 illustrates a detail of an inductive device according to an exemplifying and non-limiting embodiment of the invention. FIG. 2 shows a section view of a part of the toroidal core 201 of the inductive device, a section view of a part of the cooling element 204 of the inductive device, and cross-sections of the electric conductor 202 of the inductive device. The section plane is parallel with the xy-plane of a coordinate system 299 and perpendicular to the axial direction of the toroidal core 201. In the exemplifying case illustrated in FIG. 2, the electric conductor 202 has a substantially circular cross-section and the wall of the cylindrical cavity of the cooling element 204 is provided with axially directed, i.e. z-directional, grooves. The axially directed grooves improve the match between the wall of the cylindrical cavity and the electric conductor 202, and thereby the axially directed grooves improve the heat transfer from the electric conductor 202 to the cooling element 204. As shown in FIG. 2, the portions of the electric conductor 202 occupying the grooves are a distance apart from each other, and a distance from the wall of the cylindrical cavity of the cooling element 204 to the toroidal core 201 in a radial direction of the toroidal core 201 is less than a thickness of the portions of the electric conductor 202 in the radial direction.

In the case illustrated in FIG. 2, the cross-section of the electric conductor 202 is substantially circular and the cross-section of the cylindrical cavity of the cooling element 204 deviates from a circular shape because of the axially directed grooves. As illustrated in FIGS. 1a-1c, it also possible that the cross-section of the electric conductor deviates from a circular shape and the cross-section of the cylindrical cavity also deviates from a circular shape. Both the above-mentioned cross-sections are non-circular in the exemplifying case illustrated in FIGS. 1a-1c where the electric conductor has a rectangular cross-section, and the wall of the cylindrical cavity is provided with axially directed grooves.

In the exemplifying inductive device illustrated in FIGS. 2, the gaps between the wall of the cylindrical cavity and the above-mentioned portions of the electric conductors are filled with electrically insulating solid material. In the exemplifying case illustrated in FIG. 2, an electrically insulating outer lining 205 of the electric conductor 202 constitutes the electrically insulating solid material filling the above-mentioned gaps.

The specific examples provided in the description given above should not be construed as limiting the applicability and/or the interpretation of the appended claims. Lists and groups of examples provided in the description given above are not exhaustive unless otherwise explicitly stated.

What is claimed is:

1. An inductive device comprising:
a toroidal core,
at least one electric conductor wound around the toroidal core and constituting at least one winding, portions of the electric conductor on an outer perimeter of the winding being straight and parallel with an axial direction of the toroidal core, and
a cooling element constituting a cylindrical cavity containing the toroidal core and the electric conductor so that the axial direction of the toroidal core is parallel with an axial direction of the cylindrical cavity and distances from a wall of the cylindrical cavity to different ones of the portions of the electric conductor are substantially equal,
wherein a shape of the wall of the cylindrical cavity and a cross-sectional shape of the electric conductor are adapted to match each other so that a cross-sectional shape of the cylindrical cavity in a geometric plane perpendicular to the axial direction (z) of the cylindrical cavity deviates from a circular shape so as to improve heat transfer from the portions of the electric conductor on the outer perimeter of the winding to the wall of the cylindrical cavity, and wherein the wall of the cylindrical cavity is provided with axially directed grooves occupied by the portions of the electric conductor on the outer perimeter of the winding, the portions of the electric conductor occupying the grooves are a distance apart from each other, and a distance from the wall of the cylindrical cavity of the cooling element to the toroidal core in a radial direction of the toroidal core is less than a thickness of the portions of the electric conductor in the radial direction.

2. An inductive device according to claim 1, wherein the cross-sectional shape of the electric conductor is substantially rectangular.

3. An inductive device according to claim 1, wherein gaps between the wall of the cylindrical cavity and the portions of the electric conductors are filled with electrically insulating solid material.

4. An inductive device according to claim 3, wherein an electrically insulating outer lining of the electric conductor constitutes at least a part of the electrically insulating solid material.

5. An inductive device according to claim 1, wherein the cooling element comprises cooling fins.

6. An inductive device according to claim 1, wherein the cooling element comprises one or more cooling ducts for conducting cooling fluid.

7. An inductive device according to claim 1, wherein the cooling element comprises a bottom section constituting a bottom of the cylindrical cavity and being in a heat conductive relation with the electric conductor.

8. An inductive device according to claim 7, wherein gaps between the bottom section and the electric conductor are filled with electrically insulating solid material.

9. An inductive device according to claim 7, wherein the bottom section comprises cooling fins.

10. An inductive device according to claim 7, wherein the bottom section comprises one or more cooling ducts for conducting cooling fluid.

11. An inductive device according to claim 1, wherein the toroidal core comprises ferromagnetic material.

12. An inductive device according to claim 11, wherein the toroidal core comprises an elongated band of steel coated with electrically insulating material and reeled to constitute the toroidal core.

13. An inductive device according to claim 11, wherein the toroidal core comprises ring-shaped and planar sheets of steel coated with electrically insulating material and stacked in the axial direction of the toroidal core.
